(19) United States
(12) Patent Application Publication
(10) Pub. No.: US 2016/0294994 A1
(43) Pub. Date: Oct. 6, 2016

(54) KIND2HELP

(71) Applicant: LIZETH RUTH SORUCO, Olney, MD (US)

(72) Inventor: LIZETH RUTH SORUCO, Olney, MD (US)

(21) Appl. No.: 15/052,721

(22) Filed: Feb. 24, 2016

Related U.S. Application Data
(60) Provisional application No. 62/142,168, filed on Apr. 2, 2015.

(51) Int. Cl. H04M 1/02; H04W 4/20

(52) U.S. Cl. CPC H04M 1/0202; H04W 4/20

(57) ABSTRACT

An on-demand service request method and platform may be provided. At least one customer and at least one service provider may access the platform to request and perform services respectively. The platform may match a service provider to a customer by a desired set of parameters. A matched service provider may then choose to accept the request and perform the services. Once completed, the services may be closed and records and receipts may be generated for the customer and service provider also providing feedback for a service. A rating user interface can be provided after completion of a service. If the rating is equal to or higher than a predetermined level, the user may be enabled to share positive aspects of the service with other people. If the rating is below the predetermined level, the user may be enabled to indicate categories which the user was dissatisfied with.

### BACKGROUND

Minor household maintenance, landscape, outdoor, cleaning, auto services are performed on a daily basis by individuals or third parties for hire. These services may be tasks that can be easily and more efficiently performed by others. For example, it may be more efficient for youth to perform these tasks for an elderly neighbor. Currently, providers of these services must post flyers or advertisements, generate networks through personal contacts, or make cold-contacts to perform these services for others. It may be desirable to create an efficient and safe way for service providers to connect and perform services for customers. This may promote kindness and interaction within communities.

### SUMMARY

An on-demand service request method and platform may be provided. At least one customer and at least one service provider may access the platform to request and perform services respectively. The platform may match a service provider to a customer by a desired set of parameters. A matched service provider may then choose to accept the request and perform the services. Once completed, the service may be closed and records or receipts may be generated for the customer and service provider. A rating user interface can be provided after completion of service.

### BRIEF DESCRIPTION OF THE FIGURES

Advantage of embodiments of the present invention will be apparent from the following detailed description of the exemplary embodiments. The following detailed description should be considered in conjunction with the accompanying figures in which:

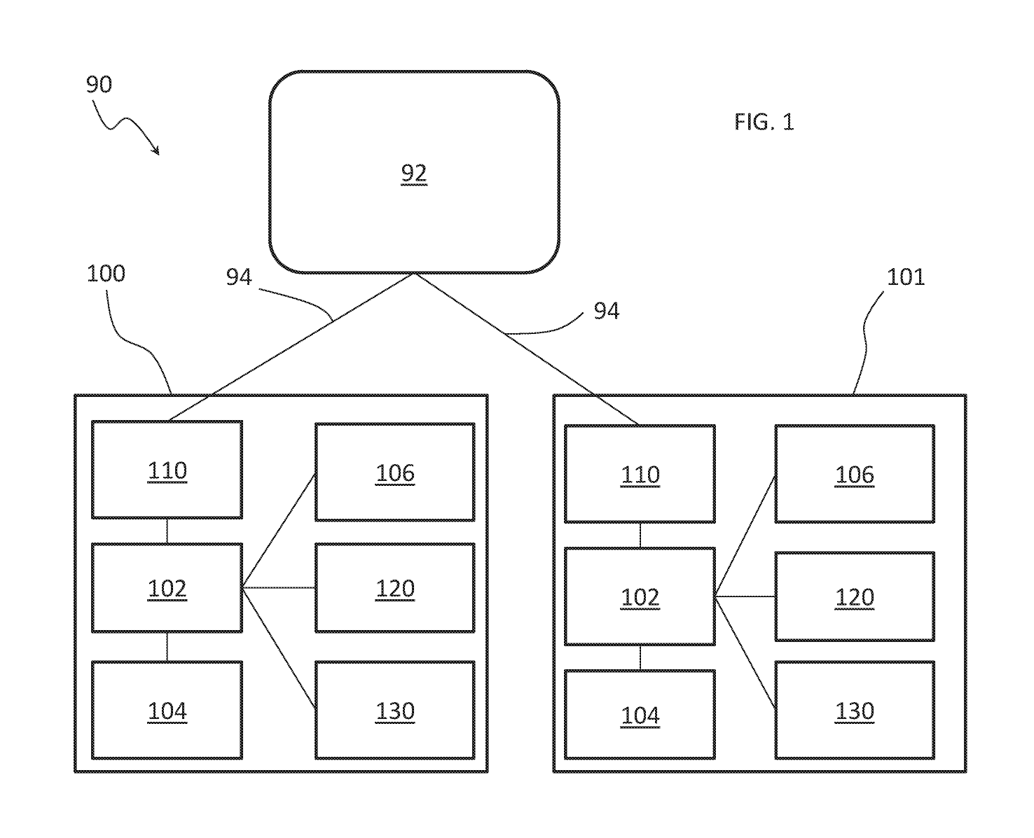

Exemplary FIG. 1 shows block diagram of an on-demand service request platform.

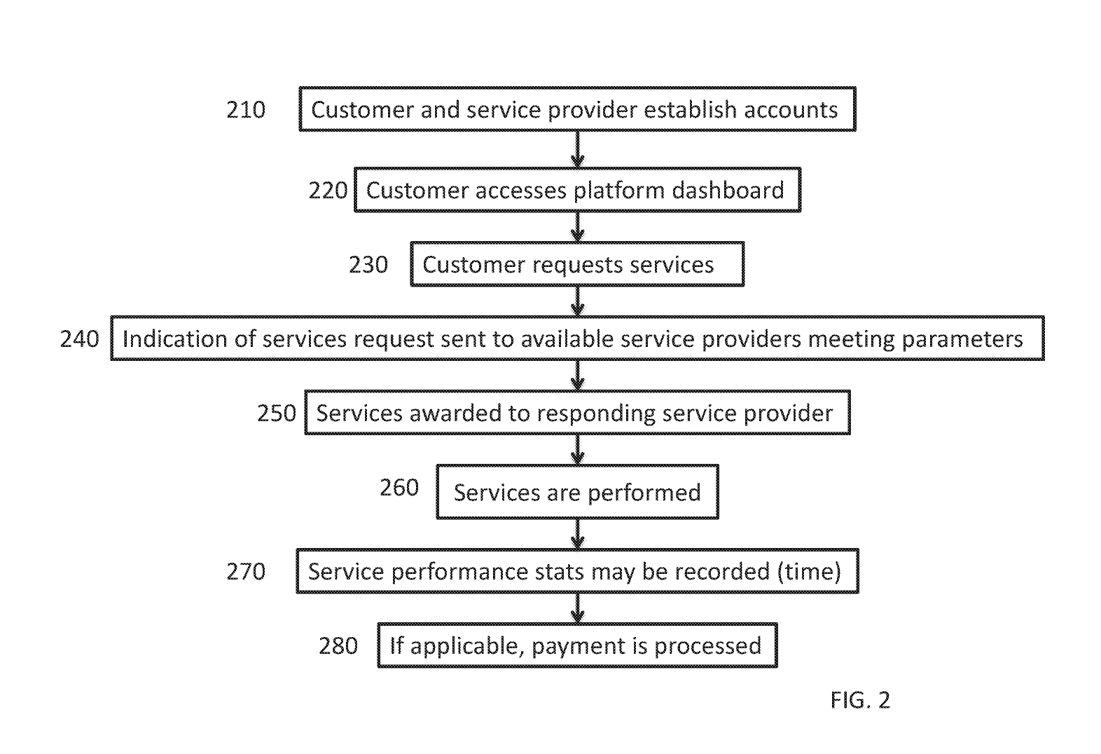

Exemplary FIG. 2 shows a method of performing on-demand services.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described or detailed or will be omitted so as not to obscure the relevant details of the invention. Further, to facilitate an understanding of the description discussion of the several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all the embodiments of the invention include the discussed feature, advantage or mode of operation.

Further, many of the embodiments described herein are described in terms of sequences of actions to be performed by, for example, elements of a computing device. It should be recognized by those skilled in the art that the various sequences of actions described herein can be performed by specific circuits (e.g. application specific integrated circuits (ASICs)) and/or by program instructions executed by at least one processor. Additionally, the sequence of actions described herein can be embodied entirely within any form of computer-readable storage medium such that execution of the sequence of actions enables the at least one processor to perform the functionality described herein. Furthermore, the sequence of actions described herein can be embodied in a combination of hardware and software. Thus, the various aspects of the present invention may be embodied in a number of different forms, all of which have been contemplated to be within the scope of the claimed subject matter. In addition, for each of the embodiments described herein, the corresponding form of any such embodiments described herein, the corresponding form of any such embodiment may be described herein as, for example, “a computer configured to” perform the described action.

According to at least one exemplary embodiment, an interactive environment or platform for enabling at least one service provider to offer services and at least one user or customer to request on-demand services may be provided. Exemplary services may include minor household maintenance, landscape, outdoor, cleaning, auto services, or other services as would be understood by a person having ordinary skill in the art. A service provider may be an individual, group of individuals, business entity, or other entity as would be understood by a person having ordinary skill in the art. A customer may include an individual, a household, business entity, or other entity as would be understood by a person having ordinary skill in the art. In some exemplary embodiments, the interactive platform may be provided through a software application or website interface. In some embodiments implemented through a software application, the software application may be used on a mobile computing device, such as a smart phone or tablet.

The platform may match or facilitate a connection between a service provider and a customer based on a set of parameters entered by each, respectively. In some alternative embodiments, the platform may generate a pool of matches, from which a customer and/or service providers may select at least one match to create a service relationship. Service providers and customers may have unique interfaces or dashboards for interacting with the platform, which may allow them to access and input necessary data. Customers and service providers may be able to create an account for accessing the platform. When creating an account, a customer or service provider may enter necessary information, including contact information, biographical information, security information, and payment processing information. The platform may optionally offer the ability, or require the creation of a profile. Some or all of the profile information may be public. When matching the service providers and customers, the platform may optionally utilize private and/or public information entered. The information used may be session specific or associated with the service provider or customer account generally.

In a exemplary embodiment, the platform may allow service providers to input data dictating parameters, which may be used for matching with potential customers. The parameters may be included in a service provider profile or may be entered for a particular session or time frame. Exemplary parameters may include biographical information, physical ability, experience, desired service offerings, time availability, online status, compensation, geographical limitations, transportation, and/or supervisor implemented limitations. In some embodiments, services may be offered for no compensation, as community service. Geographic limitations may be used in conjunction with service provider and customer mobile device location data when matching. In an exemplary embodiment where a service provider is a minor, parental or guardian permission may be required. This may be implemented though a parent or guardian entering into the minor's platform dashboard, sending a permission request to a parent or guardian, or linking a parent or guardian account to the minor service provider account, such that the parent or guardian may have permission over the minor's account.

In an exemplary embodiment, the platform may further allow a customer to enter data, which may dictate parameters used when matching. The parameters may include in a service provider profile or may be entered for a particular session or time frame. Exemplary parameters may include biographical information, service type details or identifiers, physical ability requirements, desired experience, time availability, on line status, compensation, geographic limitations, transportation requirements, and/or age limitations. As indicated above, in some embodiments, services may be offered for no compensation, as community service. In such embodiments, community service hours may be documented and may be utilized to obtain rewards and recognition, such as scholarships. Further, geographic limitations may be used in conjunction with service provider and customer mobile device location data when matching.

In at least one exemplary embodiment, a service provider and a customer may be required to be “online” or using the platform at the same time for a match to be created. This may ensure availability and facilitate a real-time, on-demand aspect. A service provider may remain “online” while performing a service; however, the platform may not show the service provider in as possible match to other customers. This may be a parameter established by the platform. The service provider may remain “online” for tracking data related to completing the service and for checking out a customer. In some exemplary embodiments, a service provider may optionally be capable of selecting from multiple matched potential customer requests. In such embodiments, the service provider may or may not have access to a description of the services requested by the potential customers.

In a exemplary embodiment, the platform may track and record service providers during performance of a service. This may be accomplished though tracking a mobile device running the platform. Tracking may not only ensure the services are being performed honestly, but it may also ensure the safety of service providers. In some further embodiments, service providers may have alarm devices, such as wearable panic button, or a panic button on a mobile computing device.

In addition to the platform account information for service providers and customers, as described above, the platform may further allow service providers and customers to enter financial account information for making and receiving payments. The platform may automate the payment process, such that funds are automatically deducted from a customer's account and funds may further be automatically deposited in a service provider's account. An administering company of the platform may serve as a payment intermediary and may take a portion payment. Payment amounts may be based on time, services, or other aspects as would be understood by a person having ordinary skill in the art. Time may be measured by the platform from the time a service provider accepts a request or arrives on site to the time an open service session is reported as close by a service provider or customer.

A non-exhausted list of exemplary minor household maintenance, landscape, outdoor, cleaning, auto services may include weeding, bush trimming, lawn mowing, holiday and special occasion decorating, raking leaves, car washing, snow shoveling, clearing snow from vehicles, house cleaning, window cleaning, painting, chopping wood, cleaning outdoor furniture and fixtures such as pools, storing and setting out outdoor furniture, jumping cables, and changing tires help, and other services as would be understood by a person having ordinary skill in the art.

Now referring to exemplary FIG. 1, a block diagram that illustrates an on-demand services platform 90 may be provided. Platform 90 may include a computing device 100/101 upon which embodiments described herein may be implemented may be provided. Platform 90 may also optionally include a platform server 92, which may store data, analyze data, perform matching functions, and/or communicate with computing devices 100/101 over at least one network 94. Computer devices 100/101 may also communicate directly via the at least one network network 94. Alternative embodiments may perform such functions among computing devices 100/101. In an exemplary embodiment, there may be at least one customer device 100 and at least one service provider device 101. In one embodiment, a computing device 100/101 may correspond to a mobile computing device, such as a cellular device that is capable of telephony, messaging, and data services. Examples of such devices may include smartphones, handsets or tablet for cellular carriers. Computing device 100/101 includes a processor 102, memory resources 104, a display device 106 (for example a touch-sensitive display device), one or more communication sub-systems 110 (including wireless communication sub-systems), input mechanisms 120 (for example an input mechanism can include or be a part of the touch-sensitive display device), and one or more location detection mechanisms (for example a GPS component) 130. In one example, at least one of the communication sub-systems 110 may send and receive cellular data over data channels and voice channels.

The processor 102 may be configured with software and/or other logic to perform one or more processes, steps and other functions described with implementations, such as described herein, and elsewhere in the application. Processor 102 may be configured with instructions and data stored in the memory resources 104, to operate an on-demand service application as described herein. For example, instructions for operating the service application to display various user interfaces, which can be stored in the memory resources 104 of the computing device 100. In one implementation, a user can operate the on-demand service application so that location data can be received by the GPS component 130. The location data can be used by the application to present user interface features that are made specific to the current location of the computing device 100.

The location data can also be provided to the on-demand service system using the communication sub-system 110. The communication sub-systems 110 can enable the computing device 100 to communicate with other servers and computing devices, for example, over a network (e.g., wirelessly or using a wireline). The location data can be communicated to the on-demand service system so that when the user requests the on-demand service, the system can arrange the service between the user and an available service provider. The communication sub-systems 110 can also receive provider information (such as location and/or movement information of service providers in real-time) from the on-demand service systems and transmit the provider information to the professor 102 for displaying provider data on one or more user interfaces.

The Processor 102 can use interface features to be presented on the display 106 by executing instructions and/or applications that are stored in the memory resources 104. In some examples, user interfaces 108 can be by the processor 102 based on user input and/or selections received from the user. In some implementations, the user can interact with the touch-sensitive display 106 to make selections on the different interface features so that region-specific information (that is based on the user selections) can be provided with the user interface features.

Now referring to exemplary FIG. 2, an on-demand service requesting platform may function as follows. At least one customer at least one service provider may create an account 210. A customer may access a platform interface through a computing device 220. The customer may request service 230. The service provider may be sent to available service providers meeting required parameters set through customer and service provider accounts 240. The service opportunity may be rewarded to a responding service provider 250. The service provider may perform the services 260. The platform may record performance statistics, such as time and other statistics as would be understood by a person having ordinary skill in the art 270. Finally, when applicable, a payment may be processed 280. In community service embodiments, a payment may include a certificate representing that the community service was completed.

The foregoing description and accompanying figures illustrate the principles, preferred embodiments and modes of operation of the invention. However, the invention should not be considered construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A mobile portable computing device (on-demand service request platform) such as a smart phone or tablet used to request an on-demand service such as minor household, landscape, maintenance, outdoor, cleaning, car service. Configured to perform the described action to reach out the service provider to connect with customer.

2. A system substantially as shown and described.

3. A method substantially as shown and described.

4. A computer program product as shown as described.
